(19) United States
(12) Patent Application Publication
(10) Pub. No.: US 2025/0243975 A1
(43) Pub. Date: Jul. 31, 2025

(54) METHODS, SYSTEMS, AND STORAGE MEDIA FOR MONITORING PIPELINE DEPOSITS BASED ON SMART GAS INTERNET OF THINGS (IOT)

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Jun WANG, Chengdu (CN); Yuefei WU, Chengdu (CN)

(73) Assignee: CHENGDU QINCHUAN IOT TECHNOLOGY CO., LTD., Chengdu (CN)

(21) Appl. No.: 19/182,698

(22) Filed: Apr. 18, 2025

(30) Foreign Application Priority Data
Feb. 24, 2025 (CN) 202510202857.X

(51) Int. Cl. F17D 5/00

(52) U.S. Cl. CPC F17D 5/005

(57) ABSTRACT

Disclosed are a method, a system, and a storage medium for monitoring pipeline deposits based on a smart gas Internet of Things (IoT). The method comprises: issuing a data acquisition command to control sensors on gas pipelines or gas valves to collect basic sensing data, and uploading the basic sensing data to a gas company management platform; determining a deposit risk region of the gas pipelines; determining a pipeline region to be inspected, generating and sending a pipeline inspection instruction to a gas pipeline network maintenance object platform; controlling an inspection robot to inspect the pipeline region to be inspected and collecting an inspection result; generating cleaning data of the gas pipelines and sending the cleaning data to a governmental safety supervision management platform; and generating a pipe-cleaning instruction and performing a pipe-cleaning operation on a portion of the gas pipelines based on the pipe-cleaning instruction.

### CROSS-REFERENCE TO RELATED APPLICATIONS

This application claims priority to Chinese Patent Application No. 202510202857.X, filed on Feb. 24, 2025, the entire contents of which are hereby incorporated by reference.

### TECHNICAL FIELD

The present disclosure relates to the field of Internet of Things (IoT), and in particular, to a method, a system, and a storage medium for monitoring pipeline deposits based on a smart gas IoT.

### BACKGROUND

Due to factors such as a change in a composition of a gas source, pipeline wear and corrosion, and an increasing age of a gas pipeline, gas often carries solid impurities and other tiny particles during transportation. The particles include dust and other contaminants, which not only affect the quality of the gas but also pose potential threats to the safe operation of a pipeline system. Therefore, types and quantities of impurities in the gas pipeline need to be estimated and assessed to determine whether the pipeline requires cleaning. The efficiency and safety of gas transportation are closely related to the cleanliness of an interior of the pipeline. Regular cleaning of the gas pipeline not only ensures the stability of the gas transmission process but also extend the lifespan of the pipeline.

To improve the ability to identify impurities in gas pipelines, CN107727541B discloses a device, a method, and a pipeline system for monitoring pipeline aerosols. The system uses an aerosol particle size spectrometer to detect a concentration and a particle size distribution of aerosols in a gas pipeline. However, the system does not investigate a potential relationship between impurities and different sections of the gas pipeline. For example, the system does not address the impact of impurities in an upstream gas pipeline on a downstream pipeline.

Therefore, it is desirable to provide a method, a system, and a storage medium for monitoring pipeline deposits based on a smart gas Internet of Things (IoT). The method can not only monitor a distribution of impurities in various gas pipelines based on a layout of the gas pipelines but also optimize a cleaning strategy for the gas pipelines based on the distribution of impurities.

### SUMMARY

To address the issues of low accuracy in monitoring deposits in different sections of gas pipeline networks and the difficulty in identifying the potential relationship between impurities and different regions of gas pipelines, the present disclosure provides a method, a system, and a storage medium for monitoring pipeline deposits based on a smart gas IoT.

One or more embodiments of the present disclosure provide a method for monitoring pipeline deposits based on a smart gas IoT. The method is executed by a gas company management platform of a system for monitoring pipeline deposits. The method comprises: issuing a data acquisition command to control sensors on gas pipelines or gas valves to collect basic sensing data, transferring the basic sensing data to a gas equipment object platform for aggregation and storage, and uploading the basic sensing data to the gas company management platform via the gas equipment object platform according to a preset reporting rule; determining, based on the basic sensing data, a deposit risk region of the gas pipelines; and determining a pipeline region to be inspected based on the deposit risk region, and generating and sending a pipeline inspection instruction to a gas pipeline network maintenance object platform, so that the gas pipeline network maintenance object platform controls an inspection robot to inspect the pipeline region to be inspected based on the pipeline inspection instruction and collects an inspection result uploaded by the inspection robot. The method further comprises: receiving the inspection result collected by the gas pipeline network maintenance object platform, generating pipeline cleaning data of the gas pipelines, and sending the pipeline cleaning data to a governmental safety supervision management platform; and receiving cleaning confirmation data returned from the governmental safety supervision management platform, generating a pipe-cleaning instruction based on the cleaning confirmation data, and performing a pipe-cleaning operation on a portion of the gas pipelines based on the pipe-cleaning instruction.

One or more embodiments of the present disclosure provide a system for monitoring pipeline deposits based on a smart gas Internet of Things (IoT). The system comprises one or more of a gas company management platform, a gas equipment object platform, a gas pipeline network maintenance object platform, and a governmental safety supervision management platform. The gas company management platform is configured to: issue a data acquisition command to control sensors on gas pipelines or gas valves to collect basic sensing data, transfer the basic sensing data to the gas equipment object platform, and receive the basic sensing data uploaded by the gas equipment object platform; determine, based on the basic sensing data, a deposit risk region of the gas pipelines; determine a pipeline region to be inspected based on the deposit risk region, and generate and send a pipeline inspection instruction to the gas pipeline network maintenance object platform; receive an inspection result collected by the gas pipeline network maintenance object platform, generate pipeline cleaning data of the gas pipelines, and send the pipeline cleaning data to the governmental safety supervision management platform; and receive cleaning confirmation data returned from the governmental safety supervision management platform, generate a pipe-cleaning instruction based on the cleaning confirmation data, and perform a pipe-cleaning operation on a portion of the gas pipelines based on the pipe-cleaning instruction. The gas equipment object platform is configured to: receive the basic sensing data collected by the sensors for aggregation and storage, and upload the basic sensing data to the gas company management platform according to a preset reporting rule; the gas pipeline network maintenance object platform is configured to: receive the pipeline inspection instruction sent by the gas company management platform, control an inspection robot to inspect the pipeline region to be inspected, collect the inspection result uploaded by the inspection robot, and send the inspection result to the gas company management platform. The governmental safety supervision management platform is configured to: receive the pipeline cleaning data sent by the gas company management platform, and generate and send the cleaning confirmation data to the gas company management platform.

One or more embodiments of the present disclosure provide a non-transitory computer-readable storage medium, the storage medium storing computer instructions, wherein when a computer reads the computer instructions in the storage medium, the computer executes the method for monitoring pipeline deposits based on the smart gas Internet of Things (IoT) described in some embodiments of the present disclosure.

### BRIEF DESCRIPTION OF THE DRAWINGS

The present disclosure will be further illustrated by way of exemplary embodiments, which are described in detail with the accompanying drawings. These embodiments are non-limiting. In these embodiments, the same count indicates the same structure, wherein:

FIG. 1 is a block diagram illustrating exemplary platforms of a system for monitoring pipeline deposits based on a smart gas Internet of Things (IoT) according to some embodiments of the present disclosure;

FIG. 2 is a flowchart of an exemplary process of a method for monitoring pipeline deposits based on a smart gas IoT according to some embodiments of the present disclosure;

FIG. 3 is a flowchart of an exemplary process for determining a deposit risk region according to some embodiments of the present disclosure;

FIG. 4 is an exemplary schematic diagram illustrating the determination of a deposit risk level according to some embodiments of the present disclosure; and

FIG. 5 is a schematic diagram of an exemplary prediction model according to some embodiments of the present disclosure.

### DETAILED DESCRIPTION

In order to more clearly illustrate the technical solutions of the embodiments of the present disclosure, the following briefly introduces the drawings that need to be used in the description of the embodiments. Apparently, the accompanying drawings in the following description are only some examples or embodiments of the present disclosure, and those skilled in the art can also apply the present disclosure to other similar scenarios according to the drawings without creative efforts. Unless obviously obtained from the context or the context illustrates otherwise, the same numeral in the drawings refers to the same structure or operation.

To effectively clean gas pipelines, it is essential to adopt an appropriate cleaning strategy that considers different types and varying amounts of deposits distributed within the pipelines, as well as physical properties of the deposits.

In view of the above, some embodiments of the present disclosure provide a method for monitoring pipeline deposits based on a smart gas IoT, which can intelligently plan an inspection sequence of the gas pipelines based on a spatial distribution of the gas pipelines and more rationally design cleaning strategies for gas pipelines that require cleaning.

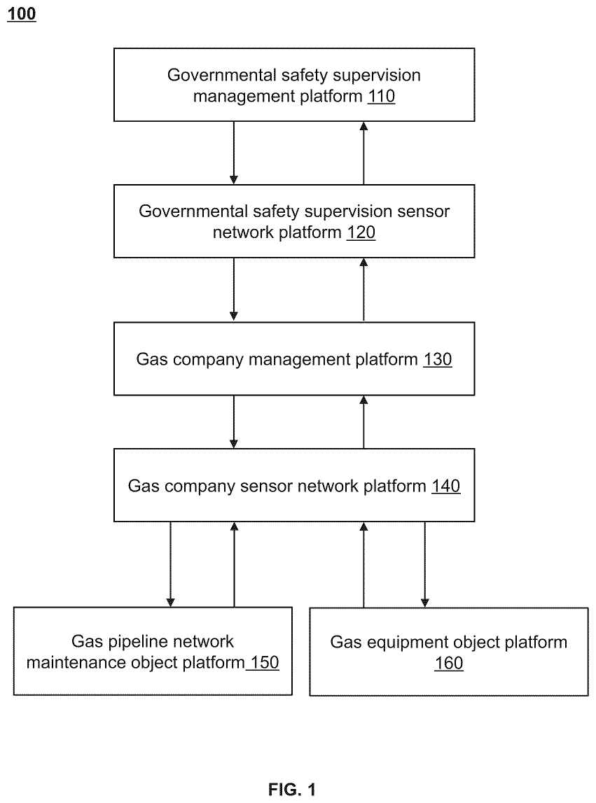

FIG. 1 is a block diagram illustrating exemplary platforms of a system for monitoring pipeline deposits based on a smart gas Internet of Things (IoT) according to some embodiments of the present disclosure. In some embodiments, as shown in FIG. 1, a system 100 for monitoring pipeline deposits based on a smart gas IoT (hereinafter referred to as the system 100) may include a governmental safety supervision management platform 110, a governmental safety supervision sensing network platform 120, a gas company management platform 130, a gas company sensing network platform 140, a gas pipeline network maintenance object platform 150, and a gas equipment object platform 160.

The governmental safety supervision management platform 110 refers to a platform for providing government information and services. In some embodiments, the governmental safety supervision management platform 110 may be configured to receive pipeline cleaning data sent by the gas company management platform 130, and generate and send cleaning confirmation data to the gas company management platform 130.

The governmental safety supervision sensing network platform 120 is configured to connect the governmental safety supervision management platform 110 and the gas company management platform 130 for information exchange.

The gas company management platform 130 refers to a platform for processing and storing data related to the system 100. In some embodiments, the gas company management platform 130 may be connected to the gas equipment object platform 160, the gas pipeline network maintenance object platform 150, and the governmental safety supervision management platform 110 for information exchange. For example, the gas company management platform 130 may generate pipeline cleaning data of the gas pipelines and send the pipeline cleaning data to the governmental safety supervision management platform 110. More descriptions of the gas company management platform 130 may be found in related descriptions below.

In some embodiments, the gas company management platform 130 may include a processor and a storage unit.

The gas company sensing network platform 140 refers to a platform that manages communications. In some embodiments, the gas company sensing network platform 140 may be configured to achieve sensing information transmission and control information transmission functions. In some embodiments, the gas company sensing network platform 140 may be configured to interact with other platforms in the system 100. For example, the pipeline cleaning data may be sent to the gas company management platform 130 via the gas company sensing network platform 140. As another example, the gas company management platform 130 may send a pipeline inspection instruction to the gas pipeline network maintenance object platform 150 via the gas company sensing network platform 140.

The gas pipeline network maintenance object platform 150 refers to a platform configured to control auxiliary facilities, pipeline maintenance equipment, and vehicles related to maintenance of a gas pipeline network. In some embodiments, the gas pipeline network maintenance object platform 150 may include a PLC controller, a data transmission device, and a storage unit, and is communicatively coupled to the pipeline maintenance equipment (e.g., an inspection robot, a pipeline locator, a pipe-cleaning machine, a combustible gas detector, etc.).

In some embodiments, the gas pipeline network maintenance object platform 150 may be configured to receive the pipeline inspection instruction sent by the gas company management platform 130, to control an inspection robot to inspect a pipeline region to be inspected, collect an inspection result uploaded by the inspection robot, and send the inspection result to the gas company management platform 130. In some embodiments, the gas pipeline network maintenance object platform 150 may include a processor and a storage unit. More descriptions of the gas pipeline network maintenance object platform 150 may be found in related description below.

In some embodiments, the gas equipment object platform 160 may be communicatively connected to the gas pipeline network maintenance object platform 150 via the gas company sensing network platform 140. In some embodiments, the gas equipment object platform 160 may be configured to receive basic sensing data transmitted by sensors, aggregate and store the basic sensing data, and upload the basic sensing data according to a preset reporting rule to the gas company management platform 130. More descriptions of the basic sensing data may be found in related descriptions below.

In some embodiments, the gas equipment object platform 160 may include a PLC controller, a data transmission device, and a storage unit. The gas equipment object platform 160 may be communicatively connected to sensors and configured to receive the basic sensing data collected by the sensors and aggregate and store the basic sensing data.

In some embodiments, the system 100 may include a processor (not shown in FIG. 1). For example, at least one of the gas company management platform 130 and the governmental safety supervision management platform 110 may include a processor. In some embodiments, the processor may process at least one of information and data related to the system 100 to perform one or more of the functions described in the present disclosure. In some embodiments, the processor may include one or more engines (e.g., a single-chip processing engine or a multi-chip processing engine). Merely by way of example, the processor may include a central processing unit (CPU), a graphics processor (GPU), a digital signal processor (DSP), etc. In some embodiments, the processor may communicate and interact with a plurality of platforms (e.g., the governmental safety supervision management platform 110, the gas company management platform 130, the gas pipeline network maintenance object platform 150, and the gas equipment object platform 160) of the system 100.

In some embodiments, the system 100 may further include a storage unit (not shown in FIG. 1). For example, one or more of the governmental safety supervision management platform 110, the gas company management platform 130, the gas pipeline network maintenance object platform 150, and the gas equipment object platform 160 may include a storage unit. In some embodiments, the storage unit may store at least one of information and data related to the system 100. For example, the gas pipeline network maintenance object platform 150 may store the inspection result obtained by the inspection robot via the storage unit.

In some embodiments of the present disclosure, the system 100 may form a closed loop of information operation among the functional platforms based on the smart gas IoT. Through coordinated and systematic operation, the system 100 enables information-based and intelligent monitoring of the deposits of the gas pipelines.

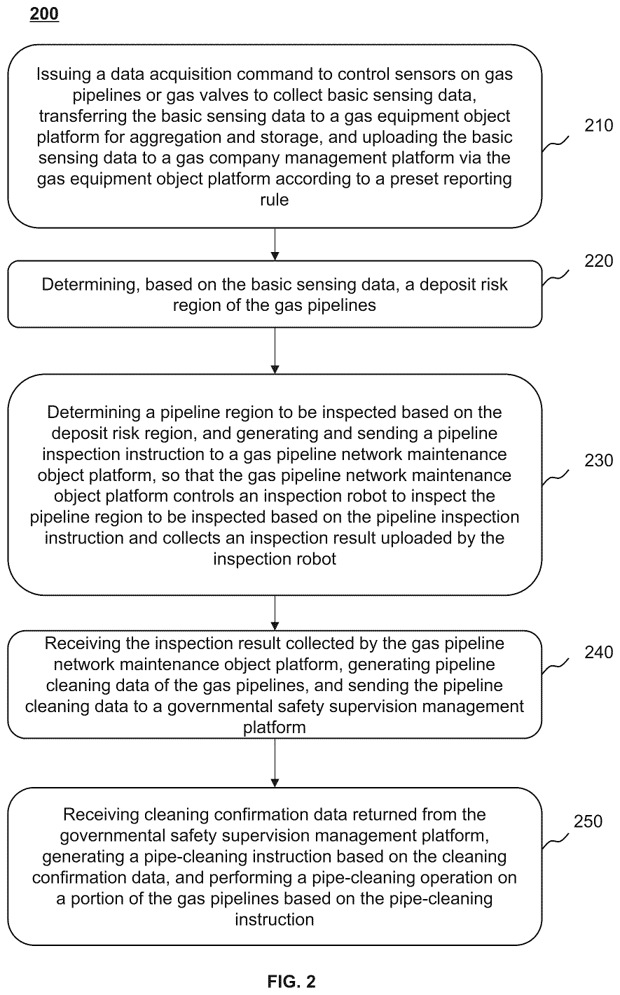

FIG. 2 is a flowchart of an exemplary process of a method for monitoring pipeline deposits based on a smart gas IoT according to some embodiments of the present disclosure. As shown in FIG. 2, process 200 includes following operations. In some embodiments, process 200 may be performed by a gas company management platform.

In 210, issuing a data acquisition command to control sensors on gas pipelines or gas valves to collect basic sensing data, transferring the basic sensing data to a gas equipment object platform for aggregation and storage, and uploading the basic sensing data to the gas company management platform via the gas equipment object platform according to a preset reporting rule.

The data acquisition command refers to a command related to data collection, aggregation, and storage, sent from the gas company management platform to the gas equipment object platform.

In some embodiments, the gas equipment object platform may collect the basic sensing data based on the data acquisition command via the sensors on the gas pipelines or the gas valves.

The gas pipelines refer to pipeline facilities configured to transport gas. The gas pipelines may be categorized into different types according to an importance level thereof. For example, the gas pipelines may be categorized into a primary pipeline, a secondary pipeline, a branch pipeline, or the like.

The gas valves refer to valves that are installed on the gas pipelines. The gas valves may be configured to adjust a gas flow rate, a gas pressure, etc., of the gas in the gas pipelines.

The sensors refer to components configured to collect parameters related to the gas. For example, the sensors may include a pressure sensor, a temperature sensor, a flow rate sensor, or the like.

The basic sensing data refers to gas-related parameters collected by the sensors. For example, the basic sensing data may include a gas temperature, the gas flow rate, the gas pressure, or the like.

The preset reporting rule may be a data processing program that is predetermined by the gas company management platform and executed by the gas equipment object platform. For example, the preset reporting rule may include regular reporting or irregular reporting. For example, the regular reporting may include reporting every 45 days, and the irregular reporting may include reporting as soon as an abnormal gas parameter is detected. The abnormal gas parameter refers to an abnormal gas temperature, an abnormal gas flow rate, an abnormal gas pressure, or the like.

In some embodiments, the preset reporting rule may be determined based on historical experience or a deposit risk level. For example, when reporting at a 14-day interval, if the deposit risk level determined by the gas company management platform based on an analysis of the basic sensing data is relatively low, the gas company management platform may appropriately extend the data reporting interval. For example, if the deposit risk levels in different gas pipeline regions are all lower than a preset risk threshold, the gas company management platform may double the reporting interval.

Understandably, if the deposit risk levels are all relatively low, it indicates that the data reporting interval is relatively short, and the accumulation of deposits within the pipelines is relatively slow.

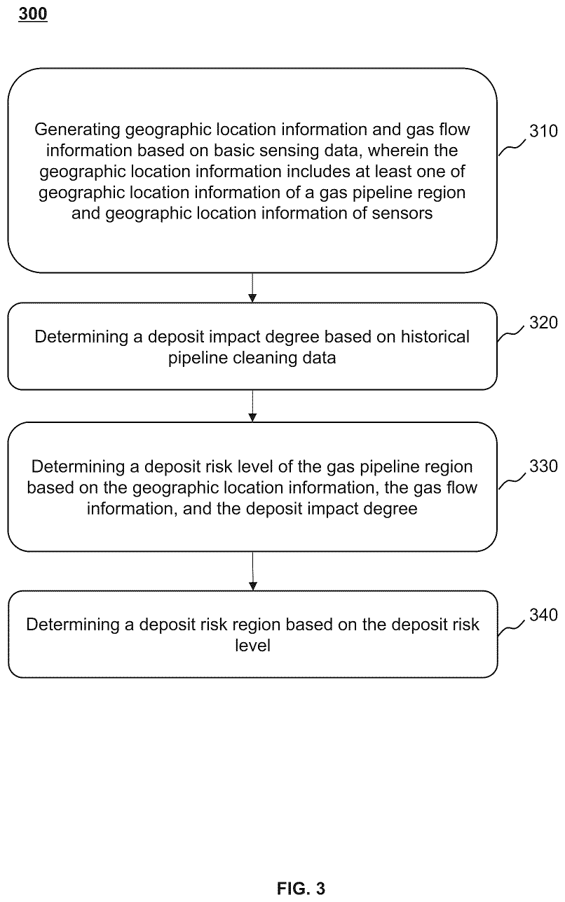

More descriptions of the deposit risk level may be found in FIG. 3 and relevant descriptions thereof.

In some embodiments, the gas equipment object platform may acquire and aggregate the basic sensing data by communicatively connecting with different sensors, and store the basic sensing data within a storage device.

For more descriptions of the gas company management platform and the gas equipment object platform, please refer to FIG. 1 and relevant descriptions.

In 220, determining, based on the basic sensing data, a deposit risk region of the gas pipelines.

The deposit risk region refers to a gas pipeline region where pipeline deposits may exist. The pipeline deposits refer to residues that accumulate on an inner wall of the gas pipelines during the transportation of the gas. For example, the residues may include hydrates, oil, sand, or the like.

The gas pipeline region refers to a region where there is a need for monitoring the pipeline deposits. In some embodiments, the gas pipeline region may be a section of a gas pipeline or a portion of a section of the gas pipeline. In some embodiments, if a plurality of sensors are disposed on a section of a gas pipeline, the gas company management platform may determine a section of the gas pipeline between every two neighboring sensors as the gas pipeline region.

In some embodiments, the gas company management platform may determine the deposit risk region in various ways based on the basic sensing data. For example, the gas company management platform may determine a difference between the basic sensing data collected by a sensor and a preset gas transportation parameter. If the difference exceeds a preset transportation difference threshold, the location of the sensor is determined as the deposit risk region.

The preset gas transportation parameter refers to a preset working parameter of the gas pipelines. The preset gas transportation parameter may be determined during the construction or planning of the gas pipelines, which ensure normal transportation of gas downstream. For example, the preset gas transportation parameter may include a preset gas transportation rate range, a preset gas pressure range, a preset gas temperature range, or the like.

In some embodiments, the preset transportation difference threshold is statistically set by the gas company management platform based on historical inspection results. For example, if in 10 historical inspection results where pipeline deposits were found, 9 of the historical inspection results showed that the difference between the pipeline's basic sensing data and the preset gas transportation parameter exceeded a value (e.g., 5%), then the value may be set as the preset transportation difference threshold.

For more descriptions of the historical inspection results, please refer to relevant descriptions of operation 230.

In 230, determining a pipeline region to be inspected based on the deposit risk region, generating and sending a pipeline inspection instruction to a gas pipeline network maintenance object platform, so that the gas pipeline network maintenance object platform controls an inspection robot to inspect the pipeline region to be inspected based on the pipeline inspection instruction and collects an inspection result uploaded by the inspection robot.

The pipeline region to be inspected refers to a gas pipeline region that needs to be checked on-site. For example, the pipeline region to be inspected may be a gas pipeline region that is inspected on-site by a detection device or the inspection robot.

In some embodiments, the gas company management platform may determine the pipeline region to be inspected in various ways based on the deposit risk region. For example, the gas company management platform may obtain a time interval between a current time and a last time when a gas pipeline region was cleaned. If the time interval is greater than a predetermined interval, the gas pipeline region is determined as the pipeline region to be inspected. The predetermined interval may be a value input by a user into the gas company management platform.

In some embodiments, the gas company management platform may determine the pipeline region to be inspected based on a difference between basic sensing data and the preset gas transportation parameter. For example, if the difference between the basic sensing data and the preset gas transportation parameter for a gas pipeline region reaches twice the preset transportation difference threshold (e.g., the preset transportation difference threshold is 5% and the difference reaches 10% or more), the gas pipeline region is determined as the pipeline region to be inspected.

The pipeline inspection instruction refers to a command related to pipeline inspection communicated between platforms and devices in the system 100. In some embodiments, the gas pipeline network maintenance object platform may send the pipeline inspection instruction to an inspection robot.

The inspection robot is a robot equipped with an inspection device. The inspection robot may be configured to check whether gas pipelines have deposits and a deposit content (e.g., a deposit thickness, etc.). For example, the inspection device may include an ultrasonic detector, a thickness gauge, etc.

The inspection result refers to analyzed data related to the inspection of the gas pipelines. For example, the inspection result may include whether there are pipeline deposits in the pipeline region to be inspected and the deposit content of the pipeline deposits. As another example, the inspection result may also include whether pipe-cleaning has been performed.

In some embodiments, the gas pipeline network maintenance object platform may aggregate inspection results uploaded by the inspection robot to generate historical inspection results.

The deposit content refers to amount of pipeline deposits that accumulate on an inner wall of a pipeline. For example, the deposit content may include a deposit thickness, a deposit volume, or the like.

In some embodiments, the gas company management platform may obtain the inspection results generated by one or more inspection robots through the gas pipeline network maintenance object platform.

In some embodiments, the gas company management platform may generate a pipeline inspection sequence based on the deposit risk level and geographic location information of the gas pipeline region, perform an on-site inspection on the pipeline region to be inspected using the inspection robot based on the pipeline inspection sequence, and obtain the inspection result.

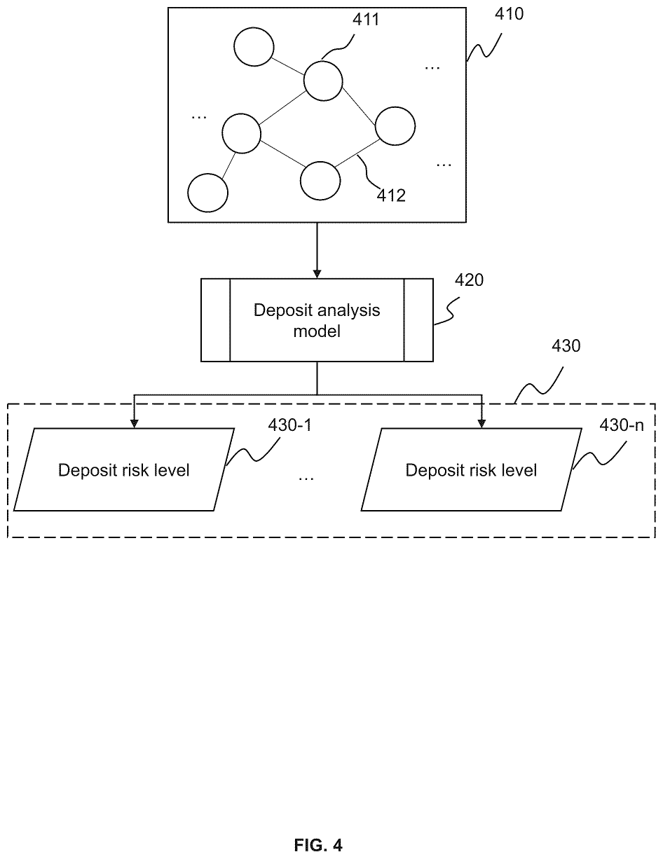

The deposit risk level refers to data that reflects the magnitude of risk associated with pipeline deposits in different gas pipeline regions. For more detailed descriptions of the deposit risk level, please refer to FIGS. 3 and 4, and relevant descriptions.

The geographic location information refers to a geographic location in which the gas pipeline region is located. For more detailed descriptions of the geographic location information, please refer to FIG. 3 and relevant descriptions.

The pipeline inspection sequence includes an order in which different pipeline regions to be inspected are inspected. The pipeline inspection sequence may be represented by Arabic numerals or English letters. For example, (AB, 3) indicates that a gas pipeline region numbered AB is scheduled to be inspected third in the pipeline inspection sequence. The pipeline inspection sequence may also include no-inspection. For example, (BC, N) indicates that a gas pipeline region numbered BC does not need be inspected.

In some embodiments, the gas company management platform may generate one or more inspection groups, each of which includes one or more adjacent pipeline regions to be inspected. The pipeline inspection sequence for each inspection group is determined by sorting based on an average deposit risk level of the pipeline regions to be inspected within each group. For example, the gas company management platform may divide different inspection routes based on a gas pipeline network, with each inspection route serving as an inspection group. Each inspection route includes a plurality of sequentially connected gas pipeline regions, and the inspection route may have a preset maximum length (e.g., 5 kilometers).

In some embodiments, the preset maximum length may be determined based on an endurance capability (e.g., a remaining battery life) of the inspection robot, which may be determined based on the historical inspection results. For example, in a last historical inspection, the inspection robot stopped working due to insufficient battery after moving 6 kilometers after being fully charged. Therefore, before a next inspection, after confirming that the inspection robot is fully charged, the preset maximum length may be set to 5.5 kilometers, and an actual usage parameter (e.g., a maximum distance moved before displaying insufficient battery) of the inspection robot may be used as reference data for determining the preset maximum length in the next inspection.

In some embodiments, the gas company management platform may determine the preset maximum length based on the endurance capability of the inspection robot, thereby ensure inspection efficiency.

In some embodiments, the gas company management platform may determine whether to inspect a pipeline region to be inspected based on the historical inspection results of pipeline regions to be inspected with deposit risk levels equal to or approximately equal to a preset risk threshold. For example, if a proportion of times that no pipe-cleaning was required in the historical inspection results of a pipeline region to be inspected is greater than a preset proportion (e.g., 0.9) input by the user into the system 100, then that pipeline region to be inspected is determined to be a region that does not require inspection this time.

For more detailed descriptions of the preset risk threshold, please refer to FIG. 3 and relevant descriptions.

In some embodiments, in response to the inspection result of a pipeline region to be inspected indicating the deposit content of the pipeline deposits in the pipeline region to be inspected satisfying a preset content condition, the gas company management platform may adjust the pipeline inspection sequence of a non-target pipeline region.

The non-target pipeline region refers to a gas pipeline region that is associated with the pipeline region to be inspected. In some embodiments, the non-target pipe may be determined based on a deposit impact degree.

In some embodiments, the gas company management platform may determine the non-target pipeline region based on edges of a pipeline network simulation map.

It may be understood that only pipeline regions downstream of a pipeline region to be inspected are associated with the pipeline region to be inspected, i.e., pipelines downstream of the pipeline region to be inspected may be affected by pipeline deposits transferred from upstream pipelines.

For more descriptions of the deposit impact degree and the pipeline network simulation map, please refer to FIGS. 3-4 and the relevant descriptions thereof.

The preset content condition includes a judgment condition for determining whether to adjust the pipeline inspection sequence of the non-target pipeline region. For example, the preset content condition may include the deposit content (e.g., the deposit thickness, etc.) being less than a preset content threshold (e.g., 3 millimeters). In some embodiments, the preset content condition may include a judgment condition for determining whether to perform pipe-cleaning.

In some embodiments, the gas company management platform may predetermine the preset content threshold based on historical basic sensing data. For example, the gas company management platform may obtain gas transportation rates in historical basic sensing data of a plurality of time periods after it is determined that no pipe-cleaning is performed, and set a minimum deposit thickness when gas transportation efficiency (e.g., the gas flow rate) is reduced due to the lack of pipe-cleaning as the preset content threshold.

In some embodiments of the present disclosure, the gas company management platform may use a preset algorithm to determine the preset content threshold. For example, the gas company management platform may determine a plurality of correlation groups based on the historical basic sensing data and historical deposit risk levels of different gas pipeline regions at different times.

A correlation group may include one gas pipeline region with an inspection result indicating no pipe-leaning is required, and two adjacent gas pipeline regions downstream of the gas pipeline region with an adjacency degree less than or equal to 2. For example, in a sequence of connected gas pipeline regions A-B-C-D-E, AB, BC, CD, and DE are four sequentially connected regions, and AB is the gas pipeline region with an inspection result indicating no pipe-leaning is required, then AB, BC, and CD may be determined as a correlation group.

The adjacency degree is a numerical value that reflects a relative positional relationship between different gas pipeline regions. For example, an adjacency degree of 2 indicates that two gas pipeline regions (e.g., AB and CD) are separated by one additional gas pipeline region (e.g., BC).

In some embodiments of the present disclosure, the gas company management platform may generate a correlation ratio of a count of correlation groups with deposit risk levels that increase twice consecutively to a total count of the correlation groups. Correlation groups with deposit risk levels that increase twice consecutively refers to that the deposit risk levels of the downstream gas pipeline regions (e.g., BC and CD) within the correlation group increase twice in a row.

For example, if a correlation group 1 includes a gas pipeline region AB with a pipeline inspection result indicating no pipe-leaning is required and two downstream adjacent gas pipeline regions BC and CD with an adjacency of less than or equal to 2, and in two subsequent analyses of deposit risk levels, the deposit risk levels of BC and CD increase each time (e.g., by 2 levels and 3 levels, respectively), then the correlation group 1 is determined as a correlation group with deposit risk levels that increase twice consecutively.

In some embodiments, if there are one or more correlation groups with a correlation ratio greater than a preset correlation threshold, the gas company management platform may determine the correlation groups as frequently correlated groups. In some embodiments, the platform may determine an average of minimum deposit thicknesses of the gas pipeline regions (e.g., the gas pipeline region AB) within the frequently correlated groups that have pipeline inspection results indicating no pipe-cleaning is required as the preset content threshold.

In some embodiments, in response to the pipeline inspection result of a pipeline region to be inspected indicating that the deposit content meets the preset content condition, the gas company management platform may identify a downstream adjacent pipeline region with a deposit impact degree not equal to 0 and already determined as a pipeline region to be inspected as the non-target pipeline region, thereby adjusting the pipeline inspection sequence of the non-target pipeline region. For more descriptions of the deposit impact degree, please refer to FIG. 3 and the relevant descriptions thereof.

Adjusting the pipeline inspection sequence of a pipeline region may include postponing the pipeline inspection sequence of the pipeline region or not inspecting the pipeline region. In some embodiments, adjusting the inspection sequence may further include: if there are other pipeline regions to be inspected near the non-target pipeline region (e.g., other gas pipeline regions adjacent to the non-target pipeline region), the gas company management platform may issue a pipeline inspection instruction to inspect the non-target pipeline region with an adjusted inspection sequence using the inspection robot.

In some embodiments, the gas company management platform may determine the pipeline regions to be inspected or non-target pipeline regions corresponding to edges in the pipeline network simulation map based on the pipeline network simulation map. The gas company management platform may adjust the inspection sequence according to the adjacency degree between different pipeline areas to be inspected and non-target pipeline regions, as well as the deposit impact degrees of the adjacent gas pipeline regions downstream of the pipeline regions to be inspected. For example, the gas company management platform may adjust the pipeline inspection sequence of non-target pipeline regions with an adjacency degree less than or equal to 2 relative to the pipeline regions to be inspected, and not adjust the inspection sequence of non-target pipeline regions with an adjacency degree greater than 2.

In some embodiments, the gas company management platform may determine an adjusted deposit risk level for the non-target pipeline region, and then re-determine the pipeline inspection sequence based on a size of the adjusted deposit risk level.

For example, the gas company management platform may determine the adjusted deposit risk level using a preset algorithm based on a positive correlation between a current deposit impact degree of the non-target pipeline region and the deposit impact degree. For example, the gas company management platform may determine the adjusted deposit risk level for the non-target pipeline region by Equation (1):

$$N = O * α , \qquad ( 1 )$$

In Equation (1), N denotes the adjusted deposit risk level of the non-target pipeline region, O denotes the current deposit risk level of the non-target pipeline region, and a denotes the current deposit impact degree of the non-target pipeline region.

For more descriptions of the pipeline network simulation map, the edges, and the deposit risk level, please refer to FIG. 3 and FIG. 4, and the relevant descriptions thereof.

In some embodiments of the present disclosure, under conditions where the personnel, materials, and equipment required for pipeline network inspections are limited, and inspection time is constrained, the gas company management platform can improve pipeline inspection efficiency by determining a reasonable pipeline inspection sequence, thereby prioritizing the inspection needs of pipeline regions with relatively high risks.

In some embodiments of the present disclosure, the gas company management platform may adjust the pipeline inspection sequence based on the deposit impact degree, allowing for a rational adjustment of the inspection order for downstream pipelines based on pipeline inspection results of upstream pipelines, thereby enhancing inspection efficiency to some extent and extending an operational duration of the inspection robot.

In 240, receiving the inspection result collected by the gas pipeline network maintenance object platform, generating pipeline cleaning data of the gas pipelines, and sending the pipeline cleaning data to a governmental safety supervision management platform. More descriptions of the governmental safety supervision management platform may be found in FIG. 1 and the related descriptions thereof.

The pipeline cleaning data refers to data related to the cleaning of the gas pipelines. For example, the pipeline cleaning data may include data such as whether a gas pipeline region requires cleaning and a scheduled cleaning time when the cleaning starts. The pipeline cleaning data may be represented as sequence data related to the cleaning of a plurality of pipelines. For example, pipeline cleaning data (AB, Y, 1.3; BC, N, N; CD, Y, 3) indicates that gas pipeline regions numbered AB and CD require cleaning (Y indicates cleaning is required, N indicates cleaning is not required), with cleaning times scheduled for 1.3 days and 3 days later, respectively, while the gas pipeline region numbered BC does not require cleaning.

In some embodiments, the gas company management platform may generate the pipeline cleaning data in various ways based on the inspection result. For example, the gas company management platform may determine whether cleaning is required and identify one or more pipeline cleaning regions based on the deposit thickness in the inspection result. For example, if the deposit thickness in a gas pipeline region reaches the preset content threshold (e.g., 3 millimeters), the gas company management platform may determine that the gas pipeline region requires cleaning and designate the gas pipeline region as a pipeline cleaning region.

As another example, the gas company management platform may generate an estimated cleaning time based on inspection results of two consecutive inspections and a time interval between the two consecutive inspections. For example, the gas company management platform may determine a deposit accumulation rate by dividing a difference between the deposit content in the two inspection results by the time interval. Then, by dividing the preset content threshold by the deposit accumulation rate and subtracting the time interval, the gas company management platform may generate the cleaning time.

In 250, receiving cleaning confirmation data returned from the governmental safety supervision management platform, generating a pipe-cleaning instruction based on the cleaning confirmation data, and performing a pipe-cleaning operation on a portion of the gas pipelines based on the pipe-cleaning instruction.

The cleaning confirmation data refers to confirmation information issued by the government safety supervision management platform related to the pipeline cleaning data. For example, cleaning confirmation data may include whether cleaning is required, the pipeline cleaning region, the cleaning time, and a cleaning sequence. For example, cleaning confirmation data (AB, Y, 1.3, 1; CD, Y, 3, 37) may indicate that the gas pipeline regions numbered AB and CD require cleaning (Y indicates cleaning is required, N indicates cleaning is not required). The cleaning time for the pipeline region AB is scheduled for 1.3 days later and the cleaning order of the pipeline region AB is the first (the pipeline region AB is the first in the cleaning sequence), while the cleaning time for the pipeline region CD is scheduled for 3 days later and the cleaning order of the pipeline region CD is the 37th (the pipeline region CD is the 37th in the cleaning sequence).

In some embodiments, the government safety supervision management platform may determine the cleaning sequence by sorting based on the cleaning times. In some embodiments, if the cleaning times for different gas pipelines are the same or similar, the government safety supervision management platform may determine the cleaning sequence based on types of the gas pipelines (e.g., main pipelines, branch pipelines, etc.) or the deposit accumulation rates of the gas pipelines. For example, if the cleaning times for the pipeline regions numbered AB and BC are both 1 day later, but pipelines in the pipeline region AB are main pipelines and pipelines in the pipeline region CD are branch pipelines, then the pipeline region AB may be prioritized over the pipeline region BC in the cleaning sequence due to its greater importance.

In some embodiments, the gas company management platform may generate a fan control instruction based on the cleaning confirmation data returned from the governmental safety supervision management platform, send the fan control instruction to the gas pipeline network maintenance object platform, and control, via the gas pipeline network maintenance object platform, a fan to operate with a preset working parameter based on the fan control instruction.

The fan control instruction refers to a command communicated between platforms and devices in the system 100 controlling the fan. For example, the fan control instruction may include the preset working parameter generated by the gas company management platform. In some embodiments, the gas pipeline network maintenance object platform may send different fan control instructions to different fans to control the fans to operate with different preset working parameters.

A fans refers to a device used to regulate the flow of gas within the gas pipelines. In some embodiments, the fan may prevent impurities in the gas from naturally depositing due to gravity while ensuring normal gas transportation within the pipelines, allowing the impurities to be transported forward with the gas. In some embodiments, an impurity collection device may be provided at a specified location in the gas pipeline (e.g., downstream of the fan).

In some embodiments, the fan may agitate gaseous or liquid gas within the pipelines to influence a flow direction of the gas, thereby reducing the deposit accumulation rate. More descriptions of the deposit accumulation rate may be found in FIG. 2 and the related descriptions thereof.

The preset working parameter refers to a predefined operating parameter for the fan, such as a power, fan blade speed, or the like.

In some embodiments, the preset working parameter may be pre-input by a user into the gas company management platform.

In some embodiments, the gas equipment object platform may issue the fan control instruction via wireless communication to set or adjust the preset working parameter for the fan.

In some embodiments, the gas company management platform may obtain a preset gas transportation parameter through the governmental safety supervision management platform, and adjust the preset working parameter based on the basic sensing data and the preset gas transportation parameter. For more descriptions of the basic sensing data and the preset gas transportation parameter, please refer to related descriptions of FIG. 2.

In some embodiments, the gas company management platform may adjust the preset working parameter in a variety of ways.

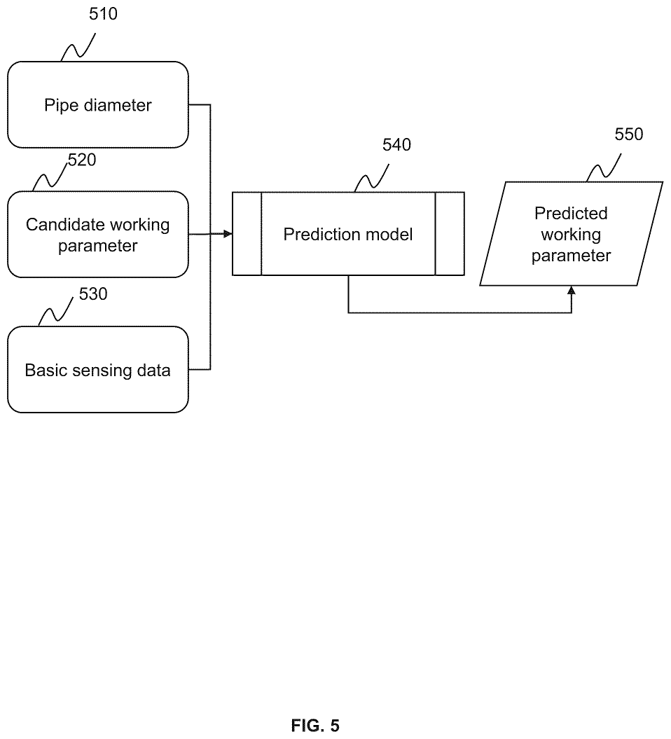

For example, the gas company management platform may adjust a preset working parameter based on a magnitude of a difference between the basic sensing data and the preset gas transportation parameter (e.g. a median value of a parameter range). For example, the gas company management platform may determine a stability level based on a magnitude of a difference between the basic sensing data and the preset gas transportation parameter. If the stability level is less than 0.9, the gas company management platform may use a prediction model to determine an adjusted preset working parameter. For more detailed descriptions of the prediction model, please refer to FIG. 5 and the relevant descriptions thereof.

The stability level refers to a degree of stability in a gas transportation process. For example, the stability degree may include a gas pressure stability level and a gas flow rate stability level. The gas pressure stability level and the gas flow rate stability level are numerical values reflecting the stability of gas pressure and gas flow rate, respectively. The higher the gas pressure stability level and the gas flow rate stability level are, the more stable the gas pressure and the gas flow rate are. The gas pressure stability level and the gas flow rate stability level may be values between 0 and 1.

In some embodiments, the stability level may be determined based on fluctuations in the gas pressure and the gas flow rate. For example, the greater the fluctuations in the gas pressure and the gas flow rate are, the lower the stability level is.

In some embodiments, the gas company management platform may determine the stability level based on the basic sensing data and the preset gas transportation parameter. For example, the gas company management platform may obtain the difference between the basic sensing data and the preset gas transportation parameter, divide the difference by the preset gas transportation parameter to determine a fluctuation value, and then assign the stability level accordingly. Merely by way of example, if the fluctuation value is within 5%, the stability level is determined to be 1; if the fluctuation value is between 5% and 15%, the stability level is determined to be 0.9.

In some embodiments of the present disclosure, the gas company management platform may adjust the preset working parameter via a machine learning model. For example, the gas company management platform may analyze a candidate working parameter using the prediction model to determine a predicted working parameter, and then adjust the preset working parameter based on the predicted working parameter.

More descriptions of the adjustment of the preset working parameter and the prediction model may be found in FIG. 5 and the relevant descriptions thereof.

In some embodiments of the present disclosure, the gas company management platform may dynamically adjust the working parameter (e.g., the power, the fan blade speed, etc.) of the fan to reduce the risk of pipeline residue or deposit formation and lower the deposit accumulation rate to some extent, thereby reducing the workload for subsequent cleaning and maintenance of the gas pipelines.

In some embodiments of the present disclosure, the gas company management platform adjusts the working parameter for the fan by considering the difference between the basic sensing data obtained by monitoring and the preset gas transportation parameter. Since a change of the monitored basic sensing data may indirectly reflect the deposit accumulation rate within the pipeline, this approach can effectively reduce the risk of pipeline residue or deposit formation and lower the deposit accumulation rate.

The pipe-cleaning instruction refers to a command related to the cleaning of gas pipelines communicated between the platforms and devices in the system 100. For example, the gas company management platform may generate and send the pipe-cleaning instruction to the gas pipeline network maintenance object platform, which then allocate personnel, materials, and equipment required for cleaning and perform the pipe-cleaning operation based on the pipe-cleaning instruction.

The pipe-cleaning operation refers to an operation related to cleaning deposits from the inner walls of the gas pipelines.

In some embodiments of the present disclosure, considering that the deposits in gas pipelines may include deposits of impurities carried by the gas and deposits of impurities generated during gas transportation due to physical aggregation or chemical reactions, the gas company management platform can reasonably identify the deposit risk region and the pipeline region to be inspected based on the collected basic sensing data. This ensures the efficiency of on-site inspections, saves pipeline inspection costs, and reduces subsequent cleaning costs

It should be noted that the foregoing descriptions of process 200 are only for illustration and description, and do not limit the scope of application of the present disclosure. For those skilled in the art, various modifications and changes may be made to process 200 under the guidance of the present disclosure. However, such modifications and changes are still within the scope of the present disclosure.

FIG. 3 is a flowchart of an exemplary process for determining a deposit risk region according to some embodiments of the present disclosure. As shown in FIG. 3, process 300 includes following operations. In some embodiments, process 300 may be performed by a gas company management platform.

In 310, based on basic sensing data, geographic location information of a gas pipeline region, geographic location information of a sensor, and gas flow information are generated.

For more descriptions of the gas pipeline region, please refer to FIG. 2 and relevant descriptions.

The geographic location information includes information related to at least one of a geographic location of the gas pipeline region and geographic location of the sensors. For example, the geographic location information may include at least one of location coordinates of the gas pipeline region and geographic coordinates of the sensors. As another example, the geographic information may be a relative positional relationship among different gas pipelines and sensors. For example, (AB, BC, −10) may indicates that a pipeline region AB is upstream of a pipeline region BC and at a distance of 10 meters from the pipeline region BC.

In some embodiments, the gas company management platform may determine, based on the basic sensing data, numbering information (e.g., a region number or a sensor number) of gas pipeline regions or sensors corresponding to the basic sensing data, thereby obtaining geographic location information of different gas pipeline regions or sensors from a governmental safety supervision management platform.

The gas flow information refers to data related to gas flow. For example, the gas flow information may include a gas flow direction, a gas flow rate, or the like.

In some embodiments, the gas company management platform may extract information such as the gas flow rate, the gas flow direction, or the like, from the basic sensing data, and then determine the gas flow information based on the gas flow rate and the gas flow direction. As another example, the gas company management platform may retrieve gas flow information of a corresponding gas pipeline region from a database of the governmental safety supervision management platform.

For a more detailed descriptions of the basic sensing data, please refer to FIG. 2 and relevant descriptions thereof.

In 320, determining a deposit impact degree based on historical pipeline cleaning data.

The historical pipeline cleaning data refers to data related to pipe-cleaning that has been performed in the past. For example, the historical pipeline cleaning data may include a historical pipe-cleaning time, a gas pipeline region corresponding to a pipe-cleaning location, a cumulative count of pipe-cleaning operations, or the like.

In some embodiments, the gas company management platform may determine historical pipeline cleaning data based on a pipe-cleaning log stored in a gas pipeline network maintenance object platform. The pipe-cleaning log refers to data that records and counts all pipe-cleaning operations.

The deposit impact degree is a numerical value of a degree of influence of pipeline deposits in a current gas pipeline region on other adjacent or connected gas pipeline regions. The larger the value of the deposit impact degree is, the greater the probability that the adjacent or connected gas pipeline regions also have similar pipeline deposits when there are deposits in the current gas pipeline region.

For more descriptions of the pipeline deposits, please refer to FIG. 2 and relevant descriptions thereof.

In some embodiments, the deposit impact degree may be a degree of influence of an upstream gas pipeline region on a downstream gas pipeline region.

In some embodiments, the gas company management platform may determine the deposit impact degree in various ways based on the historical pipeline cleaning data. For example, if there are three adjacent gas pipeline regions AB, BC, and CD, and AB, BC, and CD are all deposit risk regions, and a relationship between deposit thicknesses of the deposits in AB, BC, and CD is AB≥BC≥CD, then it may be determined that a deposit impact degree of the gas pipeline region BC is equal to a ratio of a deposit content of the pipeline deposits in the gas pipeline region BC to a deposit content of the pipeline deposits in the gas pipeline region AB, and a deposit impact degree of the gas pipeline region CD is equal to a ratio of a deposit content of the pipeline deposits in the gas pipeline region CD to a deposit content of the pipeline deposits in the gas pipeline region BC.

In some embodiments, the gas company management platform may construct a data set to be screened based on the historical pipeline cleaning data and associated historical basic sensing data. The data set to be screened comprising a plurality of subsets, each subset consisting of historical pipeline cleaning data of at least two adjacent gas pipeline regions. The gas company management platform may determine a ratio and designate the ratio as the deposit impact degree of the gas pipeline region AB. The ratio represents a proportion of subsets in the data set to be screened where the gas pipeline region AB and its upstream gas pipeline region are detected to have pipeline deposits, and the deposit thickness in the upstream gas pipeline region is greater than the deposit thickness in the downstream gas pipeline region, relative to a total count of subsets in the data set to be screened that include the gas pipeline region AB.

In 330, determining a deposit risk level of the gas pipeline region based on the geographic location information, the gas flow information, and the deposit impact degree.

The deposit risk level of a gas pipeline region refers to data that reflects a risk magnitude of deposits in the gas pipeline region. The higher the deposit risk level of a gas pipeline region is, the greater the probability of the presence of pipeline deposits in the gas pipeline region is. For example, the deposit risk level may be represented by Arabic numerals, e.g., levels 0-10, with level 10 representing a highest deposit risk level.

In some embodiments, the gas company management platform may determine the deposit risk level in a variety of ways. For example, the gas company management platform may determine a difference between the basic sensing data and a preset gas transportation parameter for different locations, and determine the deposit risk level based on a ratio of the difference to a preset transportation difference threshold. For example, if the ratio of the difference to the preset transportation difference threshold is less than 1, the deposit risk level is determined to be levels 1-5 (indicating a low risk of the presence of pipeline deposits) based on the ratio, if the ratio of the difference to the preset transportation difference threshold is equal to 1, the deposit risk level is determined to be level 5 (indicating a moderate risk of the presence of pipeline deposits), and if the ratio of the difference to the preset transportation difference threshold is greater than 1, the deposit risk level is determined to be levels 6-10, e.g., when the ratio is greater than or equals to 2, the deposit risk level is determined to be the highest level, i.e., level 10.

In some embodiments, the gas company management platform may determine deposit risk levels of the adjacent or downstream gas pipeline regions based on the deposit impact level of a current gas pipeline region. For example, if the current gas pipeline region has a deposit risk level of 10 and a deposit impact degree of 0.8, the gas company management platform may determine that an adjacent gas pipeline region downstream of the current gas pipeline region has a deposit risk level of 8.

For more descriptions of the preset transportation difference threshold, please refer to FIG. 2 and the relevant descriptions thereof.

In 340, determining the deposit risk region based on the deposit risk level.

The deposit risk region is an area of a gas pipeline where there is a possibility of pipeline deposits within the gas pipeline. For more detailed descriptions of the deposit risk region, please refer to FIG. 2 and relevant descriptions.

In some embodiments, in response to the deposit risk level satisfying a preset risk condition, the gas company management platform may determine a gas pipeline region corresponding to the deposit risk level as the deposit risk region, wherein the preset risk condition may be determined based on historical inspection results.

The preset risk condition refers to a predefined judgment rule used by the gas company management platform to determine whether a region is the deposit risk region. For example, the preset risk condition may be a preset risk threshold, such as a deposit risk level of not less than 6.

In some embodiments, the gas company management platform may determine and adjust the preset risk condition based on the historical inspection results and the historical pipeline cleaning data.

For example, the gas company management platform may adjust the preset risk condition based on a predetermined algorithm and the historical inspection results. For example, the gas company management platform may adjust the preset risk condition through Equation (2):

$$T = Y - Q 2 / Q 1 , \qquad ( 2 )$$

In Equation (2), T denotes the adjusted preset risk threshold, Y denotes an original risk threshold, Q2 denotes a count of times that clean is required in historical inspection results in which the deposit risk level is equal to the original risk threshold, and Q1 denotes a total count of times of the historical inspection results.

In some embodiments, the gas company management platform may determine the original risk threshold based on the predetermined algorithm. Exemplarily, the original risk threshold may be a preset risk threshold adjusted in a previous iteration.

In some embodiments, the original risk threshold may be a preset value determined in advance by a user and input into the gas company management platform. For example, if the user specifies that further inspection of the gas pipeline is required when the deposit risk level is level 5 or higher, the preset risk threshold may be set to level 5. In some embodiments, the gas company management platform company may determine the deposit risk level corresponding to a minimum deposit thickness of deposits in a pipeline to be inspected that requires cleaning as the original risk threshold, based on an inspection result of the pipeline to be inspected.

For example, the gas company management platform has identified 800 pipeline regions to be inspected, of which 60 pipeline regions to be inspected have a risk level exactly equal to or approximately equal to the preset risk threshold (e.g., level 5). “Approximately equal to the preset risk threshold” means being within a certain range of the preset risk threshold (e.g., within a range of ±0.5 of 5). The gas company management platform conducts inspection of the 60 pipeline regions to be inspected and identifies that 30 pipeline regions need to be cleaned, then the gas company management platform may adjust the preset risk threshold as follows: preset risk threshold=5−30/60=4.5.

In some embodiments, if a proportion of inspection results indicating that the risk level is equal to or approximately equal to the preset risk threshold and cleaning is not required exceeds a preset proportion (e.g., 0.9) for a consecutive count of times greater than or equal to a preset count (e.g., 5 times), the adjusted preset risk threshold may be increased by 0.5 from the original risk threshold.

In some embodiments, the preset count may be determined by the gas company management platform based on the historical inspection results. For example, if in the historical inspection results, the proportion of inspection results indicating that the risk level is equal to or approximately equal to the preset risk threshold and cleaning is not required exceeds the preset proportion (e.g., 0.9) for N consecutive times, and all subsequent inspection results for the gas pipeline indicates that cleaning is not required, the gas company management platform company may determine N as the preset count. The preset proportion may be a value determined by the user and input into the gas company management platform.

The historical inspection results refer to data from past pipeline inspections. For more detailed descriptions of the historical inspection results, please refer to FIG. 2 and the relevant descriptions thereof.

In some embodiments of the present disclosure, by determining the deposit impact degree, the gas company management platform can determine a relationship between deposit impact degrees of deposits in different gas pipeline regions that is in line with actual conditions, thereby providing reliable data support for subsequent division of the deposit risk level and determination of the deposit impact region.

In some embodiments of the present disclosure, the gas company management platform dynamically sets and adjusts the preset risk threshold based on the historical inspection results, which can effectively ensures cleaning efficiency and quality while reducing cleaning costs to a certain extent.

It should be noted that the above descriptions of process 300 are only for illustration and description, and do not limit the scope of application of the present disclosure. For those skilled in the art, various modifications and changes can be made to process 300 under the guidance of the present disclosure. However, such modifications and changes are still within the scope of the present disclosure.

FIG. 4 is an exemplary schematic diagram illustrating the determination of a deposit risk level according to some embodiments of the present disclosure.

As shown in FIG. 4, a gas company management platform may be configured to construct a pipeline network simulation map 410, and based on the pipeline network simulation map 410, generate a deposit risk level 430 (as shown in FIGS. 4 as 430-1 and 430-n) for each of one or more edges 412 of the pipeline network simulation map 410 via a deposit analysis model 420.

The pipe network simulation map 410 refers to a knowledge graph that reflects an actual location relationship between sensors and gas pipelines. The knowledge graph refers to a data structure comprising nodes 411 and edges 412.

In some embodiments, the nodes 411 of the pipe network simulation map 410 may represent sensors, and the edges 412 of the pipe network simulation map 410 may represent gas pipelines between the sensors. In some embodiments, node attributes of the nodes 411 of the pipe network simulation map 410 may include a deposit impact degree, basic sensing data, pipeline location information, etc., and edge attributes of the edges 412 may include a deposit risk level. In some embodiments, the edges 412 of the pipeline network simulation map 410 may be directed edges, and a direction of the edges 412 indicates a direction of gas flow in the gas pipelines. More descriptions of the basic sensing data, the deposit impact degree, and the deposit risk level may be found in FIGS. 2-3 and the relevant descriptions thereof.

The pipeline location information refers to geographic locations of the gas pipelines where the sensors are located.

In some embodiments, the gas company management platform may construct the pipeline network simulation map 410 based on sensors and the gas pipelines between the sensors, using the deposit impact degree, the basic sensing data, and the pipeline location information as the node attributes, and the deposit risk level as the edge attributes. For example, the gas company management platform may designate each sensor as a node in the pipeline network simulation map 410. As another example, if a gas pipeline exists between sensors, the nodes 411 corresponding to the sensors at two ends of the pipeline are connected to form the edges 412 of the pipeline network simulation map 410.

In some embodiments, the gas company management platform may construct the pipeline network simulation map 410 based on a distribution of a gas pipeline network in which the gas pipelines are located. For example, the gas company management platform may extract information such as positional coordinates of all gas pipelines in a target region, diameters of the gas pipelines, connection relationships of all the gas pipelines in the target region, etc., through a Geographic Information System (GIS), extract a positional coordinate of the each sensor in the gas pipeline network, and match the extracted information with the gas pipelines in the GIS. For each sensor, the gas company management platform may extract information such as the basic sensing data of the each sensor. Finally, the gas company management platform may draw corresponding edges 412 in the pipeline network simulation map 410 based on an actual connection relationship of the gas pipelines between each sensor.

The deposit analysis model 420 refers to a model configured to generate the deposit risk level 430. In some embodiments, the deposit analysis model 420 may be a machine learning model, e.g., the deposit analysis model 420 may be a graph neural network (GNN), or the like.

In some embodiments, an input of the deposit analysis model 420 may include the pipeline network simulation map 410. In some embodiments, an output of the deposit analysis model 420 may include the deposit risk level 430, e.g., a deposit risk level corresponding to each of the edges 412 in the pipeline network simulation map 410.

In some embodiments, the gas company management platform may train the deposit analysis model 420 based on a large count of first training samples with first labels. In some embodiments, the first training samples include sample pipe network simulation maps. In some embodiments, the first labels may be historical deposit risk levels corresponding to the edges 412 in the sample pipeline network simulation maps. In some embodiments, the gas company management platform inputs the first training samples into an initial deposit analysis model to obtain model prediction outputs corresponding to the first training samples. The gas company management platform constructs a loss function based on the model prediction outputs corresponding to the first training samples and the first labels corresponding to the first training samples. The gas company management platform inversely updates model parameters of the initial deposit analysis model using an optimization algorithm, such as a gradient descent manner, based on a value of the loss function. When an end-of-iteration condition (e.g., the loss function converges, a count of iterations reaches a predetermined iteration threshold, etc.) is satisfied, the gas company management platform ends the iterations and obtains the trained deposit analysis model 420.

In some embodiments, the gas company management platform may construct the first training sample based on a historical deposit impact degree, historical basic sensing data, historical pipeline location information, and a historical deposit risk level 430 determined at a historical time. In some embodiments, the historical deposit risk level may be determined based on an actual measured deposit thickness in the historical pipeline cleaning data. For example, the gas company management platform may pre-determine different deposit risk levels 430 based on actual measured deposit thicknesses. For example, if a measured deposit thickness is 3 millimeters, then the deposit risk level 430 corresponding to the measured deposit thickness is level 5. In some embodiments, the deposit risk level 430 corresponding to each deposit thickness may be predetermined based on experience; e.g., the greater the actual measured deposit thickness of deposits in a gas pipeline is, the higher the deposit risk level 430 of the gas pipeline is, i.e., the higher the value of the edge attribute (e.g., a grade, etc.) of the edge in the pipeline network simulation map 410 corresponding to the gas pipeline is. In some embodiments, the gas company management platform may construct the first label based on the historical deposit risk level determined at a historical time.

In some embodiments of the present disclosure, the gas company management platform constructs a pipeline network simulation map by using sensors as nodes and gas pipelines as edges, which can simulate spatial relationships of the gas pipelines in the gas pipeline network, thus enabling the deposit analysis model to learn location characteristics of the gas pipelines. Based on the pipeline network simulation map, the deposit analysis model is configured to predict the deposit impact degree of each gas pipeline, so as to more accurately assess the deposit risk levels of different gas pipelines.

FIG. 5 is a schematic diagram of an exemplary prediction model according to some embodiments of the present disclosure.

In some embodiments, as shown in FIG. 5, a gas company management platform may be configured to determine a candidate working parameter 520 of a fan based on a deposit risk level of a gas pipeline region and an inspection result, determine a predicted working parameter 550 corresponding to the candidate working parameter 520 through a prediction model 540 based on the candidate working parameter 520, a pipe diameter 510, and basic sensing data 530, and adjust a preset working parameter based on the predicted working parameter 550. More descriptions of the deposit risk level, the basic sensing data, and the preset working parameter may be found in FIGS. 2-4 and the related descriptions thereof.

The candidate working parameter 520 may be determined in a variety of ways. In some embodiments, the gas company management platform may determine a plurality of candidate working parameters 520 by querying a fan parameter table based on deposit risk levels of gas pipeline regions and inspection results.

In some embodiments, the gas company management platform may construct the fan parameter table based on historical deposit risk levels and historical inspection results. For example, the gas company management platform may determine proven effective fan working parameters, when the condition that the historical deposit risk levels and the historical inspection results are known, as the candidate working parameters that corresponds to the historical deposit risk levels and the inspection results for query or use.

For example, if a fan operating parameter is applied to a fan in a gas pipeline region corresponding to a deposit risk level A and an inspection result M, and subsequently, the deposit risk level of the gas pipeline region is reduced or a deposit content in the inspection result decreases, the gas company management platform may set the fan operating parameter as the candidate fan parameter corresponding to the deposit risk level A and the inspection result M in the fan parameter table.

More descriptions of the candidate working parameter 520 may be found in FIG. 3 and the relevant descriptions thereof.

The pipe diameter 510 refers to a size of an inner diameter of a gas pipeline region, i.e., a size of a diameter of an internal space of a gas pipeline.

In some embodiments, the gas company management platform may determine the pipe diameter 510 corresponding to each gas pipeline region by querying a pipe diameter table. The pipe diameter table is a database for storing gas pipeline regions and pipe diameters corresponding to the gas pipeline regions.

In some embodiments, the gas company management platform may determine the pipe diameter 510 by deploying a distance sensor (e.g., a laser rangefinder, an ultrasonic sensor, etc.) on an inspection robot.

More descriptions of the basic sensing data 530 may be found in FIG. 3 and the related descriptions thereof.

The prediction model 540 is a model configured to determine the predicted working parameters 550. In some embodiments, the prediction model 540 may be a machine learning model, e.g., a recurrent neural network (RNN), or the like.

In some embodiments, an input of the prediction model 540 may include the candidate working parameter 520, the pipe diameter 510, and the basic sensing data 530. In some embodiments, an output of the prediction model 540 may include the predicted working parameters 550.

In some embodiments, the predicted working parameter 550 may include at least one of a predicted impurity deposition amount, a predicted gas pressure stability level, and a predicted gas flow rate stability level.

The impurity deposition amount refers to an amount (e.g., a thickness of the deposits) of pipeline deposits (e.g., solid polymers, dust, etc.) within the gas pipeline. The predicted impurity deposition refers to a predicted amount of impurity deposition.

The gas pressure stability level refers to a value used to measure the fluctuation of pressure within the gas pipeline. For example, the higher the gas pressure stability level is, the smoother the gas flow is. The predicted gas pressure stability level refers to an estimated gas pressure stability level.

The gas flow rate stability level refers to a value used to measure the fluctuation of gas flow speed within the gas pipeline. For example, the higher the gas flow rate stability level is, the smoother the gas flow is. The predicted gas flow rate stability level refers to an estimated gas flow stability.

For more descriptions of the predicted working parameter 550, please refer to FIGS. 2-3 and the relevant descriptions thereof.

In some embodiments of the present disclosure, the gas company management platform may train the prediction model 540 based on a large count of second training samples with second labels, using a gradient descent technique, or the like.

In some embodiments, the second training sample may include a sample working parameter, a sample pipe diameter, sample basic sensing data, etc., at a first historical time. In some embodiments, the second label may include an impurity deposition amount, a gas pressure stability level, and a gas flow rate stability level at a second historical time corresponding to the second training samples. The first historical time is earlier than the second historical time.

In some embodiments, the gas company management platform may construct the second training samples by obtaining historical pipe diameters, historical basic sensing data, and historical working parameters collected at the first historical time from a storage unit. In some embodiments, the gas company management platform may construct the second training samples based on impurity deposition amounts, gas pressure stability levels, and gas flow rate stability levels corresponding to the second training samples, which are obtained by actual monitoring at the second historical time. In some embodiments, the gas company management platform may determine the impurity deposition amount, the gas pressure stability level, and the gas flow rate stability level at the second historical time based on the basic sensing data, the candidate working parameter, and the inspection result at the first historical time corresponding to the second training sample. The stability level (e.g., the gas pressure stability level and the gas flow rate stability level) may be determined based on fluctuations. For example, if the fluctuation is within 5%, the stability level is 1; if the fluctuation is between 5% and 15%, the stability level is 0.9.

In some embodiments of the present disclosure, the gas company management platform may cross-train the prediction model 540 by using different sets of training samples. In some embodiments, the gas company management platform may determine different training data sets based on at least one of impurity deposition amounts, gas pressure stability levels, and gas flow rate stability levels at historical times.

For example, the gas company management platform may set second training samples, where the fluctuation trend in at least one of the impurity deposition amount, the gas pressure stability level, and the gas flow rate stability level is less than a fluctuation threshold, as training samples of a same set of training samples. Second training samples where the fluctuation trend in at least one of the impurity deposition amount, the gas pressure stability level, and the gas flow rate stability level is equal to or greater than the fluctuation threshold may be set as training samples of another set of training samples. The gas company management platform may then cross-train the prediction model 540 using the training samples from different sets of training samples. In some embodiments, the fluctuation threshold may be preset based on experience.

In some embodiments, the gas company management platform may train an initial prediction model through a plurality of rounds of iterations, wherein at least one round of iterations includes: the gas company management platform selects one or more sets of second training samples, inputs the one or more sets of second training samples into the initial prediction model, and obtains a model prediction output corresponding to the one or more sets of second training samples. The gas company management platform inputs the model prediction output corresponding to the one or more sets of second training samples and one or more sets of second labels corresponding to the one or more sets of second training samples to a predefined loss function to determine a value of the loss function. The gas company management platform inversely updates model parameters of the initial prediction model using an optimization algorithm such as a gradient descent technique based on the value of the loss function. When an end-of-iteration condition is satisfied (e.g., the loss function converges, a count of the iterations reaches a predetermined iteration threshold, etc.), the gas company management platform ends the iterations and obtains the prediction model 540.

In some embodiments, different sets of training samples correspond to different learning rates during the training of the prediction model. For example, a set of training samples with a higher count of training samples may have a higher learning rate than a set of training samples with a lower count of training samples.

In some embodiments, the gas company management platform may evaluate predicted working parameters 550 based on the predicted impurity deposition amount, the predicted gas pressure stability level, and the predicted gas flow rate stability level in a variety of ways to filter a matching predicted working parameter 550.

In some embodiments, the predicted working parameter 550 may have a negative correlation with the predicted impurity deposition amount, and a positive correlation with the predicted gas pressure stability level and the predicted gas flow rate stability level. For example, the gas company management platform may evaluate the predicted working parameter 550 through Equation (3):

$$S = {w}_{1} * {x}_{1} + {w}_{2} * {x}_{2} + {w}_{3} * {x}_{3} , \qquad ( 3 )$$

In Equation (3), S denotes an evaluation score of the preset working parameter, x₁ denotes the predicted impurity deposition, x₂ denotes the predicted gas pressure stability level, x₃ denotes the predicted gas flow rate stability level, w₁ denotes a weight coefficient of the predicted impurity deposition amount, w₂ denotes a weight coefficient of the predicted gas pressure stability level, and w₃ denotes a weight coefficient of the predicted gas flow rate stability level.

In some embodiments, the gas company management platform may determine w₁, w₂ and w₃ in a plurality of ways based on historical gas supply data. For example, the gas company management platform may perform a statistical analysis on the historical gas supply data. When a change magnitude of each of an impurity deposition amount, a gas pressure, and a gas flow rate in the historical gas supply data reaches a magnitude threshold (e.g., 20%, etc.), the gas company management platform may determine w₁, w₂ and w₃ based on an influence degree of downstream gas usage.

In some embodiments, the gas company management platform adjusts w₁, w₂, and w₃ based on a proportion of a user complaint type. For example, if a user reports insufficient gas pressure, the gas company management platform may appropriately increase the value of w₂. In some embodiments, the magnitude threshold may be predetermined based on experience.

In some embodiments, in Equation (3), w₁ may be negative, and w₂ and w₃ may be positive.

In some embodiments, the gas company management platform company may select an appropriate predicted working parameter 550 from a plurality of predicted working parameters 550 and set a preset working parameter corresponding to the appropriate predicted working parameter 550 as the preset working parameter for each fan. For example, the gas company management platform may evaluate the predicted operating parameters 550 using Equation (3), identify a predicted operating parameter 550 with a highest evaluation score, and set the preset working parameter corresponding to the predicted operating parameter 550 with the highest evaluation score as a current preset working parameter for a target fan.

In some embodiments of the present disclosure, by introducing the prediction model to predict the working parameter for the fan, the gas company management platform can improve the accuracy of the predicted working parameter for the fan, thereby enhancing the fan's performance. By training and optimizing the prediction model using a large amount of historical data, the gas company management platform enables the prediction model to more accurately predict in-pipe data (e.g., the impurity deposition amount, the gas pressure stability level, the gas flow rate stability level, etc.) of the gas pipelines in future time periods, allowing the selection of the appropriate preset working parameter for the fan, thereby improving the fan's cleaning efficiency.

The basic concepts are described above. Obviously, for those skilled in the art, the above detailed disclosure is only an example, and does not constitute a limitation to the present disclosure. Although not expressly stated here, those skilled in the art may make various modifications, improvements, and corrections to the present disclosure. Such modifications, improvements and corrections are suggested in present disclosure, so such modifications, improvements, and corrections still belong to the spirit and scope of the exemplary embodiments of the present disclosure.

Meanwhile, the present disclosure uses specific words to describe the embodiments of the present disclosure. For example, “one embodiment,” “an embodiment,” and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This manner of disclosure does not, however, imply that the subject matters of the disclosure requires more features than are recited in the claims. Rather, claimed subject matters may lie in less than all features of a single foregoing disclosed embodiment.

In some embodiments, numbers describing the quantity of components and attributes are used. It should be understood that such counts used in the description of the embodiments use the modifiers “about,” “approximately,” or “substantially” in some examples. Unless otherwise stated, “about”, “approximately” or “substantially” indicates that the stated figure allows for a variation of +20%. Accordingly, in some embodiments, the numerical parameters used in the disclosure and claims are approximations that may vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for monitoring pipeline deposits based on a smart gas Internet of Things (IoT), the method being executed by a gas company management platform of a system for monitoring pipeline deposits based on the smart gas Internet of Things (IoT), and the method comprising:
issuing a data acquisition command to control sensors on gas pipelines or gas valves to collect basic sensing data, transferring the basic sensing data to a gas equipment object platform for aggregation and storage, and uploading the basic sensing data to the gas company management platform via the gas equipment object platform according to a preset reporting rule;
determining, based on the basic sensing data, a deposit risk region of the gas pipelines;
determining a pipeline region to be inspected based on the deposit risk region, and generating and sending a pipeline inspection instruction to a gas pipeline network maintenance object platform, so that the gas pipeline network maintenance object platform controls an inspection robot to inspect the pipeline region to be inspected based on the pipeline inspection instruction and collects an inspection result uploaded by the inspection robot;
receiving the inspection result collected by the gas pipeline network maintenance object platform, generating pipeline cleaning data of the gas pipelines, and sending the pipeline cleaning data to a governmental safety supervision management platform; and
receiving cleaning confirmation data returned from the governmental safety supervision management platform, generating a pipe-cleaning instruction based on the cleaning confirmation data, and performing a pipe-cleaning operation on a portion of the gas pipelines based on the pipe-cleaning instruction.

2. The method of claim 1, wherein the determining, based on the basic sensing data, a deposit risk region of the gas pipelines includes:
generating geographic location information and gas flow information based on the basic sensing data, wherein the geographic location information includes at least one of geographic location information of a gas pipeline region and geographic location information of the sensors;
determining a deposit impact degree based on historical pipeline cleaning data;
determining a deposit risk level of the gas pipeline region based on the geographic location information, the gas flow information, and the deposit impact degree; and
determining the deposit risk region based on the deposit risk level.

3. The method of claim 2, further comprising:
constructing a pipeline network simulation map, wherein nodes of the pipeline network simulation map correspond to the sensors, edges of the pipeline network simulation map correspond to gas pipelines between the sensors, and node attributes of the nodes include the deposit impact degree; and
generating, based on the pipeline network simulation map, a deposit risk level for each of one or more of the edges through a deposit analysis model, wherein the deposit analysis model is a machine learning model.

4. The method of claim 2, wherein the determining the deposit risk region based on the deposit risk level includes:
in response to determining that the deposit risk level satisfies a preset risk condition, determining a gas pipeline region corresponding to the deposit risk level as the deposit risk region, wherein the preset risk condition is determined based on a historical inspection result.

5. The method of claim 1, further comprising:
generating a pipeline inspection sequence based on a deposit risk level and geographic location information of a gas pipeline region; and
performing an on-site inspection on the pipeline region to be inspected using the inspection robot based on the pipeline inspection sequence, and obtaining the inspection result.

6. The method of claim 5, further comprising:
in response to the inspection result indicating a deposit content satisfying a preset content condition, adjusting the pipeline inspection sequence of a non-target pipeline region; wherein the non-target pipeline region is a pipeline associated with the gas pipeline region corresponding to the inspection result, and the non-target pipeline region is determined based on the deposit impact degree.

7. The method of claim 1, further comprising:
generating a fan control instruction based on the cleaning confirmation data returned from the governmental safety supervision management platform, and sending the fan control instruction to the gas pipeline network maintenance object platform; and
controlling, via the gas pipeline network maintenance object platform, a fan to operate with a preset working parameter based on the fan control instruction.

8. The method of claim 7, further comprising:
determining a candidate working parameter for the fan based on a deposit risk level of a gas pipeline region and the inspection result;
determining a predicted working parameter corresponding to the candidate working parameter through a prediction model based on the candidate working parameter, a pipe diameter, and the basic sensing data, wherein the prediction model is a machine learning model; and
adjusting the preset working parameter based on the predicted working parameter.

9. The method of claim 7, further comprising:
acquiring a preset gas transportation parameter through the governmental safety supervision management platform; and
adjusting the preset working parameter based on the basic sensing data and the preset gas transportation parameter.

10. A system for monitoring pipeline deposits based on a smart gas Internet of Things (IoT), the system comprising one or more of a gas company management platform, a gas equipment object platform, a gas pipeline network maintenance object platform, and a governmental safety supervision management platform; wherein,
the gas company management platform is configured to:
issue a data acquisition command to control sensors on gas pipelines or gas valves to collect basic sensing data, transfer the basic sensing data to the gas equipment object platform, and receive the basic sensing data uploaded by the gas equipment object platform;
determine, based on the basic sensing data, a deposit risk region of the gas pipelines;
determine a pipeline region to be inspected based on the deposit risk region, and generate and send a pipeline inspection instruction to the gas pipeline network maintenance object platform;
receive an inspection result collected by the gas pipeline network maintenance object platform, generate pipeline cleaning data of the gas pipelines, and send the pipeline cleaning data to the governmental safety supervision management platform; and
receive cleaning confirmation data returned from the governmental safety supervision management platform, generate a pipe-cleaning instruction based on the cleaning confirmation data, and perform a pipe-cleaning operation on a portion of the gas pipelines based on the pipe-cleaning instruction;
the gas equipment object platform is configured to:
receive the basic sensing data collected by the sensors for aggregation and storage, and upload the basic sensing data to the gas company management platform according to a preset reporting rule;
the gas pipeline network maintenance object platform is configured to:
receive the pipeline inspection instruction sent by the gas company management platform, control an inspection robot to inspect the pipeline region to be inspected, collect the inspection result uploaded by the inspection robot, and send the inspection result to the gas company management platform; and
the governmental safety supervision management platform is configured to:
receive the pipeline cleaning data sent by the gas company management platform, and generate and send the cleaning confirmation data to the gas company management platform.

11. The system of claim 10, wherein the gas company management platform is further configured to:
generate geographic location information and gas flow information based on the basic sensing data, wherein the geographic location information includes at least one of geographic location information of a gas pipeline region and geographic location information of the sensors;
determine a deposit impact degree based on historical pipeline cleaning data;
determine a deposit risk level of the gas pipeline region based on the geographic location information, the gas flow information, and the deposit impact degree; and
determine the deposit risk region based on the deposit risk level.

12. The system of claim 11, wherein the gas company management platform is further configured to:
construct a pipeline network simulation map, wherein nodes of the pipeline network simulation map correspond to the sensors, edges of the pipeline network simulation map correspond to gas pipelines between the sensors, and node attributes of the nodes include the deposit impact degree; and
generate, based on the pipeline network simulation map, a deposit risk level for each of one or more of the edges through a deposit analysis model, wherein the deposit analysis model is a machine learning model.

13. The system of claim 11, wherein the gas company management platform is further configured to:
in response to determining that the attachment risk level satisfies a preset risk condition, determine a gas pipeline region corresponding to the deposit risk level as the deposit risk region, wherein the preset risk condition is determined based on a historical inspection result.

14. The system of claim 10, wherein the gas company management platform is further configured to:
generate a pipeline inspection sequence based on a deposit risk level and geographic location information of a gas pipeline region; and
perform an on-site inspection on the pipeline region to be inspected using the inspection robot based on the pipeline inspection sequence, and obtain the inspection result.

15. The system of claim 10, wherein the gas company management platform is further configured to:
in response to the inspection result indicating a deposit content satisfying a preset content condition, adjust the pipeline inspection sequence of a non-target pipeline region; wherein the non-target pipeline region is a pipeline associated with the gas pipeline region corresponding to the inspection result, and the non-target pipeline region is determined based on the deposit impact degree.

16. The system of claim 10, wherein the gas company management platform is further configured to:
generate a fan control instruction based on the cleaning confirmation data returned from the governmental safety supervision management platform, and send the fan control instruction to the gas pipeline network maintenance object platform; and
control, via the gas pipeline network maintenance object platform, a fan to operate with a preset working parameter based on the fan control instruction.

17. The system of claim 16, wherein the gas company management platform is further configured to:
determine a candidate working parameter for the fan based on a deposit risk level of a gas pipeline region and the inspection result;
determine a predicted working parameter corresponding to the candidate working parameter through a prediction model based on the candidate working parameter, a pipe diameter, and the basic sensing data, wherein the prediction model is a machine learning model; and
adjust the preset working parameter based on the predicted working parameter.

18. The system of claim 16, wherein the gas company management platform is further configured to:
acquire a preset gas transportation parameter through the governmental safety supervision management platform; and
adjust the preset working parameter based on the basic sensing data and the preset gas transportation parameter.

19. A non-transitory computer-readable storage medium, the storage medium storing computer instructions, wherein when a computer reads the computer instructions in the storage medium, the computer executes a method for monitoring pipeline deposits based on a smart gas Internet of Things (IoT), the method being executed by a gas company management platform of a system for monitoring pipeline deposits based on the smart gas Internet of Things (IoT), and the method comprising:
issuing a data acquisition command to control sensors on gas pipelines or gas valves to collect basic sensing data, transferring the basic sensing data to a gas equipment object platform for aggregation and storage, and uploading the basic sensing data to the gas company management platform via the gas equipment object platform according to a preset reporting rule;
determining, based on the basic sensing data, a deposit risk region of the gas pipelines;
determining a pipeline region to be inspected based on the deposit risk region, and generating and sending a pipeline inspection instruction to a gas pipeline network maintenance object platform, so that the gas pipeline network maintenance object platform controls an inspection robot to inspect the pipeline region to be inspected based on the pipeline inspection instruction and collects an inspection result uploaded by the inspection robot;
receiving the inspection result collected by the gas pipeline network maintenance object platform, generating pipeline cleaning data of the gas pipelines, and sending the pipeline cleaning data to a governmental safety supervision management platform; and
receiving cleaning confirmation data returned from the governmental safety supervision management platform, generating a pipe-cleaning instruction based on the cleaning confirmation data, and performing a pipe-cleaning operation on a portion of the gas pipelines based on the pipe-cleaning instruction.
